(19) United States
(12) Patent Application Publication
(10) Pub. No.: US 2021/0149089 A1
(43) Pub. Date: May 20, 2021

(54) DISPLAY DEVICE

(71) Applicants: BEIJING BOE DISPLAY TECHNOLOGY CO., LTD., Beijing (CN); BOE TECHNOLOGY GROUP CO., LTD., Beijing (CN)

(72) Inventors: Yifu CHEN, Beijing (CN); Lingdan BO, Beijing (CN); Yingying QU, Beijing (CN); Ting DONG, Beijing (CN); Zhiyu LV, Beijing (CN); Jianhua HUANG, Beijing (CN)

(21) Appl. No.: 17/012,892

(22) Filed: Sep. 4, 2020

(30) Foreign Application Priority Data
Nov. 20, 2019 (CN) 201911141713.9

(51) Int. Cl. G02B 5/00; G02B 5/20; G02B 5/30

(52) U.S. Cl. CPC G02B 5/003; G02B 5/3025; G02B 5/20

(57) ABSTRACT

The present disclosure provides a display device, including: a display panel including a first substrate and a second substrate arranged opposite to each other to form a cell, the display panel being provided with a bonding side, and the first substrate extending beyond the second substrate at the bonding side to form a bonding region on the first substrate; a first polarizer arranged at a side of the first substrate away from the second substrate; and a second polarizer arranged at a side of the second substrate away from the first substrate. An edge of the second polarizer extends beyond an edge of the second substrate at the bonding side of the display panel, a gap is formed between a portion of the edge of the second polarizer extending beyond the edge of the second substrate and the bonding region on the first substrate, and a filler is arranged in the gap.

### CROSS-REFERENCE TO RELATED APPLICATION

The present application claims priority to Chinese patent application No. 201911141713.9 filed on Nov. 20, 2019. The entire contents of the above-listed application is hereby incorporated by reference for all purposes.

### TECHNICAL FIELD

The present disclosure relates to the field of display technology, in particular to a display device.

### BACKGROUND

Along with the development of the display industry, a bezel-free display technology has become a mainstream in the field of display technology. As a principle of the bezel-free display technology, a bezel of a display device, which should have been exposed to the outside, is integrated into a body and integrated with a panel of the display device. Through this design, it is able to provide the display device with well appearance, and provide a large viewable area for a user to some extent.

### SUMMARY

In one aspect, the present disclosure provides in some embodiments a display device, including: a display panel including a first substrate and a second substrate arranged opposite to each other to form a cell, the display panel being provided with a bonding side, and the first substrate extending beyond the second substrate at the bonding side to form a bonding region on the first substrate; a first polarizer arranged at a side of the first substrate away from the second substrate; and a second polarizer arranged at a side of the second substrate away from the first substrate. An edge of the second polarizer extends beyond an edge of the second substrate at the bonding side of the display panel, a gap is formed between a portion of the edge of the second polarizer extending beyond the edge of the second substrate and the bonding region on the first substrate, and a filler is arranged in the gap.

In a possible embodiment of the present disclosure, the side of the second substrate away from the first substrate is a display side of the display panel.

In a possible embodiment of the present disclosure, the first substrate is an array substrate, and the second substrate is a color filter substrate.

In a possible embodiment of the present disclosure, the edge of the second polarizer also extends beyond an edge of the first substrate at the bonding side of the display panel.

In a possible embodiment of the present disclosure, the edge of the second polarizer extends beyond the edge of the first substrate by 1 mm to 3 mm at the bonding side of the display panel.

In a possible embodiment of the present disclosure, the filler includes a black filling adhesive filled between the second polarizer and the bonding region on the first substrate, a black matrix is arranged at a surface of the second substrate facing the first substrate, and the black filling adhesive and the black matrix together form a light-shielding structure.

In a possible embodiment of the present disclosure, an inner side of the black filling adhesive is a side adjacent to a display region of the display panel, and an outer side of the black filling adhesive is a side away from the display region of the display panel. The inner side of the black filling adhesive is flush with the edge of the second substrate at the bonding side, and the outer side of the black filling adhesive extends beyond the edge of the second polarizer and is flush with a surface of the second polarizer away from the second substrate.

In a possible embodiment of the present disclosure, a light-shielding layer is further arranged on the edge of the second polarizer at the bonding side of the display panel, and in a direction perpendicular to the first substrate, the light-shielding layer at least covers a gap between the black filling adhesive and the black matrix but does not cover a display region of the display panel.

In a possible embodiment of the present disclosure, the filler includes a filling adhesive filled between the second polarizer and the bonding region on the first substrate, and a black sealant coated at an outer side of the filling adhesive. The outer side of the filling adhesive is a side away from a display region of the display panel. A light-shielding layer is arranged on the edge of the second polarizer at the bonding side of the display panel, and in a direction perpendicular to the first substrate, the light-shielding layer at least covers a gap between the black sealant and a black matrix on the second substrate but does not cover the display region of the display panel. The black matrix is arranged at a surface of the second substrate facing the first substrate. An orthogonal projection of the black sealant in the direction perpendicular to the first substrate partially overlaps an orthogonal projection of the light-shielding layer in the direction perpendicular to the first substrate, and the orthogonal projection of the light-shielding layer in the direction perpendicular to the first substrate partially overlaps an orthogonal projection of the black matrix on the second substrate in the direction perpendicular to the first substrate.

In a possible embodiment of the present disclosure, the filling adhesive is at least partially filled between the second substrate and the first substrate, an inner side of the black sealant is a side adjacent to the display region of the display panel and adhered to the filling adhesive, an outer side of the black sealant is a side away from the display region of the display panel, and the outer side of the black sealant extends beyond the edge of the second polarizer at the bonding side and is flush with a surface of the second polarizer away from the second substrate.

In a possible embodiment of the present disclosure, the filler includes a filling spacer filled between the second polarizer and the bonding region on the first substrate, and a black sealant coated at an outer side of the filling spacer. The outer side of the filling spacer is a side away from a display region of the display panel. A light-shielding layer is arranged on the edge of the second polarizer at the bonding side of the display panel, and in a direction perpendicular to the first substrate, the light-shielding layer at least covers a gap between the black sealant and a black matrix on the second substrate but does not cover the display region of the display panel. The black matrix is arranged at a surface of the second substrate facing the first substrate. An orthogonal projection of the black sealant in the direction perpendicular to the first substrate partially overlaps an orthogonal projection of the light-shielding layer in the direction perpendicular to the first substrate, and the orthogonal projection of the light-shielding layer in the direction perpendicular to the first substrate partially overlaps an orthogonal projection of the black matrix on the second substrate in the direction perpendicular to the first substrate.

In a possible embodiment of the present disclosure, the filling spacer includes glass spacers and/or plastic spacers laminated one on another.

In a possible embodiment of the present disclosure, an inner side of the filling spacer is a side adjacent to the display region of the display panel and flush with the edge of the second substrate, an inner side of the black sealant is a side adjacent to the display region of the display panel, an outer side of the black sealant is a side away from the display region of the display panel, and the outer side of the black sealant extends beyond the edge of the second polarizer at the bonding side and is flush with a surface of the second polarizer away from the second substrate.

In a possible embodiment of the present disclosure, the display panel further includes a side other than the bonding side, the edge of the first substrate is flush with the edge of the second substrate at the side other than the bonding side, and a black sealant is coated on the edge of the first substrate and the edge of the second substrate. An inner side of the black sealant is a side adjacent to the display region of the display panel, an outer side of the black sealant is a side away from the display region of the display panel, and the outer side of the black sealant extends beyond the edge of the second polarizer at the side other than the bonding side and is flush with a surface of the second polarizer away from the second substrate.

### BRIEF DESCRIPTION OF THE DRAWINGS

FIG. 1 is a schematic view showing a display device at a bonding side according to one embodiment of the present disclosure;

FIG. 2 is a schematic view showing the display device at a side other than the bonding side according to one embodiment of the present disclosure;

FIG. 3 is another schematic view showing the display device at the bonding side according to one embodiment of the present disclosure;

FIG. 4 is yet another schematic view showing the display device at the bonding side according to one embodiment of the present disclosure; and

FIG. 5 is still yet another schematic view showing the display device at the bonding side according to one embodiment of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person of ordinary skills. Such words as “first” and “second” used in the present disclosure are merely used to differentiate between different components rather than to represent any order, number or importance. Similarly, such words as “one” or “one of” are merely used to represent the existence of at least one member, rather than to limit the number thereof. Such words as “include” or “including” intends to indicate that an element or object before the word contains an element or object or equivalents thereof listed after the word, without excluding any other element or object. Such words as “connect/connected to” or “couple/coupled to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

The following will be given before the detailed description on a display device in the embodiments of the present disclosure.

In a conventional bezel-free display design, a display panel includes a color filter substrate and an array substrate arranged opposite to each other to form a cell. The array substrate is arranged at an inner side (i.e., at a back surface of the display panel), and the color filter substrate is arranged at an outer side (i.e., at a display surface of the display panel). At a side where a Chip On Film (COF) bonding region of the display panel is located, the array substrate of the display panel extends beyond the color filter substrate, so as to form a step-like side. Due to the existence of a COF bonding structure and the step-like side, the display panel is uneven at the side where the COF bonding region is located. Hence, it is necessary to provide a bezel to cover the step-like side and the COF bonding structure, and at this time, it is impossible to provide a bezel-free design at four sides.

In addition, when the array substrate of the conventional display panel is arranged at the outer side, there may exist the following problems.

When the array substrate is arranged at the outer side, metal wires at a display region are exposed to the outside, and external light is reflected by the metal wires, so contrast at the display region decreases. When the display device is turned off, the external light is reflected by a metal block at a periphery of a display screen, so a wide bright wire is formed and surrounds a non-display region, and thereby the entire appearance of a black surface of the display device is adversely affected. During the manufacture of the array substrate, a metal substrate may be blackened using a blackening process, so as to absorb the external light and reduce the reflectivity, but this may lead to an increase in the complexity of a manufacturing process as well as a decrease in the yield and cost. In addition, the step-like side is formed as a large transparent region, and special treatment needs to be performed at the periphery of the display panel. For example, a printing process with black ink needs to be performed at the periphery of the display panel, so as to prevent the external light from being reflected by the metal block at the periphery of the display panel, prevent the occurrence of light leakage at the step-like side, and ensure the entire appearance of the black surface of the display device. However, the printing process with the black ink is complex.

In order to solve the above problems, as shown in FIGS. 1 to 5, the present disclosure provides in some embodiments a display device, which includes: a display panel including a first substrate 100 and a second substrate 200 arranged opposite to each other to form a cell, the display panel being provided with a bonding side, and the first substrate 100 extending beyond the second substrate 200 at the bonding side to form a bonding region on the first substrate 100; a first polarizer 300 arranged at a side of the first substrate 100 away from the second substrate 200; and a second polarizer 400 arranged at a side of the second substrate 200 away from the first substrate 100. An edge of the second polarizer 400 extends beyond an edge of the second substrate 200 at the bonding side of the display panel, a gap is formed between a portion of the edge of the second polarizer 400 extending beyond the edge of the second substrate 200 and the bonding region on the first substrate 100, and a filler is arranged in the gap.

In a possible embodiment of the present disclosure, a chip on film 101 may be arranged at the bonding region.

According to the embodiments of the present disclosure, the edge of the first substrate 100, may extend beyond the second substrate 200 at the bonding side of the display panel, which forms a step-like structure, the second polarizer 400 attached onto the second substrate 200 may extend the edge of the second substrate 20, and the filler may be arranged between the second polarizer 400 and the second substrate 200. In this way, the second substrate 200 may be arranged in such a manner as to face outward (i.e., the side of the second substrate 200 away from the first substrate 100 may serve as a display side of the display panel). The second polarizer attached onto the second substrate may be of a flat surface, and the filler may be provided to flatten the step-like structure at the bonding side, so it is able to provide a flat display surface and provide the display device with a bezel-free design at four sides. As a result, it is unnecessary to provide a separate bezel at the bonding side any more, so it is able to provide the display panel with a bezel-free design at the bonding side, thereby to provide the bezel-free design at four sides.

It should be appreciated that, in the display device in the embodiments of the present disclosure, the first substrate 100 may be an array substrate, and the second substrate 200 may be a color filter substrate. The side of the second substrate 200 away from the first substrate 100 may be the display side of the display panel.

In this regard, when the color filter substrate of the display panel is arranged in such a manner as to face outward, i.e., when the side of the color filter substrate away from the array substrate serves as the display side of the display panel, it is also able to prevent the occurrence of the step-like structure at the bonding side for the display panel and provide the display panel with a flat display surface. Hence, it is unnecessary to provide a separate bezel at the bonding side of the display panel, so it is able to provide the bezel-free design at four sides. In addition, it is able to prevent the occurrence of light reflection caused by metal wires when the first substrate faces outward, and it is unnecessary to provide any blackening process for a metal substrate during the manufacture of the first substrate as well as a printing process with black ink at a periphery of the display panel in a module process.

It should be further appreciated that, for the display device in the embodiments of the present disclosure, the second substrate 200 may be arranged in such a manner as to face outward, but it does not mean that the display device is merely capable of being applied to this scenario. In actual use, the first substrate 100 may also be arranged in such a manner as to face outward.

It should be further appreciated that, the first substrate 100 may be an array substrate and the second substrate 200 may be a color filter substrate. However, the first substrate 100 and the second substrate 200 may not be limited thereto. The display device may be applied as long as a step-like side is formed when the first substrate 100 extends beyond the second substrate 200.

The display device will be described hereinafter in more details.

As shown in FIG. 1, the edge of the second polarizer 400 may also extend beyond an edge of the first substrate 100 at the bonding side of the display panel. For example, the edge of the second polarizer 400 may extend beyond the edge of the first substrate 100 by 1 mm to 3 mm at the bonding side of the display panel.

Based on the above scheme, it is able to simplify a process when the filler is arranged between the second polarizer 400 and the first substrate 100. For example, when the filler is a filling adhesive and the edge of the second polarizer 400 extends the edge of the first substrate 100 by 1 mm to 3 mm, it is able to facilitate the application of the filling adhesive.

More details will be given hereinafter in conjunction with the embodiments.

### First Embodiment

FIG. 1 shows the display device according to the first embodiment of the present disclosure.

As shown in FIG. 1, in the first embodiment of the present disclosure, the filler may include a black filling adhesive 601 filled between the second polarizer 400 and the bonding region on the first substrate 100, a black matrix 210 may be arranged at a surface of the second substrate 200 facing the first substrate 100, and the black filling adhesive 601 and the black matrix 210 at the edge of the second substrate 200 may together form a light-shielding structure.

In this structure, light leakage at the bonding side of the display panel may be absorbed through the black filling adhesive 601. This structure is simple and easily implemented. To be specific, it is merely necessary to fill the black filling adhesive 601 at the bonding side after the first substrate 100 is arranged opposite to the second substrate 200 to form a cell. Hence, it is able to reduce the complexity in the manufacture process and reduce the manufacture cost.

In addition, at the bonding side of the display panel, apart from the edge of the second substrate 200, the edge of the second polarizer 400 may extend beyond the edge of the first substrate 100 by approximately 1 mm to 3 mm. In this way, it is able to fill the black filling adhesive 601 more easily between the second polarizer 400 and the first substrate 100.

In addition, in the first embodiment of the present disclosure, as shown in FIG. 1, an inner side of the black filling adhesive 601 may be a side adjacent to a display region of the display panel, and an outer side of the black filling adhesive may be a side away from the display region of the display panel. The inner side of the black filling adhesive may be flush with the edge of the second substrate 200 at the bonding side, and the outer side of the black filling adhesive may extend beyond the edge of the second polarizer 400 and may be flush with a surface of the second polarizer 400 away from the second substrate 200.

Based on the above scheme, the black filling adhesive 601 may be filled in the gap between the second polarizer 400 and the first substrate 100, so as to flatten the step-like structure at the bonding side of the display panel, and meanwhile shield light to prevent the occurrence of light leakage at the bonding side. In addition, the black filling adhesive may also serve as a sealant of the display panel.

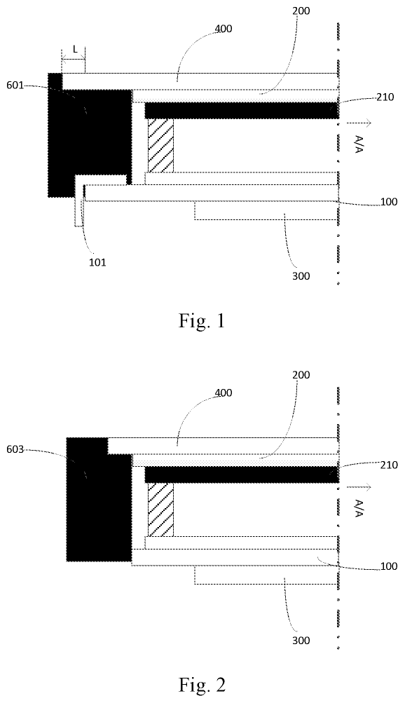

In addition, in the first embodiment of the present disclosure, as shown in FIG. 2, apart from the bonding side, the display panel may further include the other sides. At the other sides, the edge of the first substrate 100 may be flush with the edge of the second substrate 200, and a black sealant 603 may be applied to the edge of the first substrate 100 and the edge of the second substrate 200. An inner side of the black sealant 603 may be a side adjacent to an edge of the display panel, and an outer side of the black sealant 603 may be a side away from the display region of the display panel. At the other sides, the outer side of the black sealant 603 may extend beyond the edge of the second polarizer 400 and may be flush with the surface of the second polarizer 400 away from the second substrate 200.

Based on the above scheme, at the sides of the display panel other than the bonding side, the edge of the first substrate 100 may be flush with the edge of the second substrate 200, so it is merely necessary to apply the black sealant, so as to prevent the occurrence of light leakage and seal the sides.

### Second Embodiment

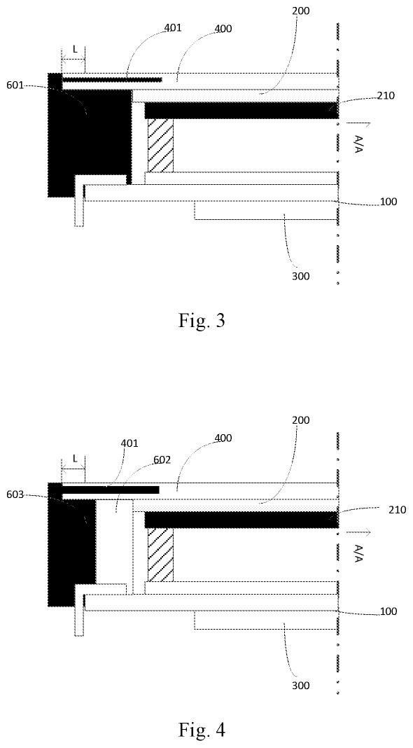

FIG. 3 shows the display device according to the second embodiment of the present disclosure.

As shown in FIG. 3, this embodiment differs from the first embodiment merely in that a light-shielding layer 401 is further arranged at the edge of the second polarizer 400 at the bonding side of the display panel. In a direction perpendicular to the first substrate, the light-shielding layer 401 may at least cover a gap between the black filling adhesive 601 and the black matrix 210, and may not cover the display region of the display panel.

Based on the above scheme, in order to prevent the occurrence of light leakage due to the gap between the black filling adhesive 601 and the black matrix 210 on the second substrate 200, the light-shielding layer 401 may be further arranged at the edge of the second polarizer 400 at the bonding side. In the direction perpendicular to the first substrate, the light-shielding layer 401 may at least cover the gap between the black filling adhesive 601 and the black matrix 210, so as to prevent the occurrence of the light leakage due to the gap therebetween. In addition, the light-shielding layer 401 may not cover the display region of the display panel, so as to prevent the light-shielding layer from interfering with the display region of the display panel.

It should be appreciated that, in the second embodiment of the present disclosure, the light-shielding layer 401 may be merely arranged at the edge of the second polarizer 400 at the bonding side, or may be arranged at an entire periphery of the second polarizer 400.

It should be further appreciated that, in the second embodiment of the present disclosure, as compared with a conventional polarizer, the second polarizer 400 has been improved, i.e., the light-shielding layer 401 may be arranged on the second polarizer 400. As a basic structure, the polarizer may include an intermediate polyvinyl alcohol (PVA) layer, two triacetyl cellulose (TAC) layers, a polysulfonamide (PSA) film, a release film, a protective film, and the light-shielding layer 401. The two TAC layers may be arranged at two sides of the PVA layer respectively, the PSA film may be arranged on one TAC layer, the release film may be arranged on the PSA film, and the protective film may be arranged on the other TAC layer. The light-shielding layer 401 may be arranged on an intermediate layer of the polarizer (e.g., on the PVA layer).

It should be further appreciated that, in the first embodiment of the present disclosure, merely the black filling adhesive 601 may be applied between the second polarizer 400 and the first substrate 100, and the second polarizer 400 may be a conventional one, so it is able to simplify the manufacture process and reduce the manufacture cost. However, the light leakage may probably occur due to the gap between the black sealant and the black matrix on the second substrate. In the second embodiment of the present disclosure, the light-shielding layer 401 may be arranged on the second polarizer 400, so it is able to improve a light shielding effect as compared with the structure in the first embodiment of the present disclosure.

### Third Embodiment

FIG. 4 shows the display device according to the third embodiment of the present disclosure.

As shown in FIG. 4, in the third embodiment of the present disclosure, the filler may include a filling adhesive 602 filled between the second polarizer 400 and the bonding region on the first substrate 100, and a black sealant 603 coated at an outer side of the filling adhesive 602. The outer side of the filling adhesive 602 may be a side away from the display region of the display panel. A light-shielding layer 401 may be arranged on the edge of the second polarizer 400 at the bonding side of the display panel, and in a direction perpendicular to the first substrate, the light-shielding layer 401 may at least cover a gap between the black sealant and a black matrix but may not cover the display region of the display panel. An orthogonal projection of the black sealant 603 in the direction perpendicular to the first substrate may partially overlap an orthogonal projection of the light-shielding layer 401 in the direction perpendicular to the first substrate, and the orthogonal projection of the light-shielding layer 401 in the direction perpendicular to the first substrate may partially overlap an orthogonal projection of the black matrix 210 on the second substrate 200 in the direction perpendicular to the first substrate, so that the black sealant 603, the light-shielding layer 401 and the black matrix 210 may together form a light-shielding structure.

Based on the above scheme, after the formation of a cell and the completion of COF bonding, the second polarizer 400 may be attached, so that the orthogonal projection of the light-shielding layer 401 of the second polarizer 400 partially overlaps the orthogonal projection of the black matrix 210 in the direction perpendicular to the first substrate. Then, the filling adhesive 602 may be filled in the gap between the second polarizer 400 and the bonding region on the first substrate 100. The filling adhesive 602 may be an ultraviolet (UV)-curable adhesive or a thermosetting adhesive. After the filling adhesive 602 has been cured, the black sealant 603 may be applied and cured so as to prevent the light leakage at the sides.

In the third embodiment of the present disclosure, as shown in FIG. 4, the filling adhesive 602 may be at least partially filled between the second substrate 200 and the first substrate 100, an inner side of the black sealant 603 may be a side adjacent to the display region of the display panel, and an outer side of the black sealant 603 may be a side away from the display region of the display panel. The outer side of the black sealant 603 may extend beyond the edge of the second polarizer 400 at the bonding side and may be flush with the surface of the second polarizer 400 away from the second substrate 200.

Based on the above scheme, the filling adhesive 602 may be filled in the gap between the second polarizer 400 and the second substrate 200, so as to provide a support and flatten the step-like structure. Through the black sealant 603, it is able to seal the periphery of the display panel. In addition, the black sealant 603 may cooperate with the light-shielding layer 401 and the black matrix 210 to form a light-shielding structure, so as to prevent the occurrence of light leakage.

In addition, in the third embodiment of the present disclosure, as shown in FIG. 2, the display panel may further include a side other than the bonding side, the edge of the first substrate 100 may be flush with the edge of the second substrate 200 at the side other than the bonding side, and the black sealant 603 may be coated on the edge of the first substrate 100 and the edge of the second substrate 200. An inner side of the black sealant 603 may be a side adjacent to the display region of the display panel, an outer side of the black sealant 603 may be a side away from the display region of the display panel, and the outer side of the black sealant 603 may extend beyond the edge of the second polarizer 400 at the side other than the bonding side and may be flush with the surface of the second polarizer 400 away from the second substrate 200.

Based on the above scheme, no step-like side may be provided at the side of the display panel other than the bonding side, and the edge of the first substrate 100 may be flush with the edge of the second substrate 200. Hence, it is merely necessary to apply the black sealant 603 to prevent the occurrence of light leakage and seal the sides. In addition, the black sealant may be applied to the bonding side and the other sides through a same sealant application process, so it is able to simplify the manufacture process.

It should be appreciated that, in the third embodiment of the present disclosure, the filling adhesive and the black sealant may together form a filler, so as to flatten the step-like structure and prevent the occurrence of light leakage. As compared with the first and second embodiments where the filler is merely formed by the black filling adhesive, in the third embodiment of the present disclosure, the black sealant may be applied to the bonding side and the other sides through a same sealant application process. However, in the first and second embodiments of the present disclosure, the black filling adhesive at the bonding side and the black sealant at the other sides may be applied through different application processes. Hence, it is able to simplify the application process of the black sealant in the third embodiment of the present disclosure.

### Fourth Embodiment

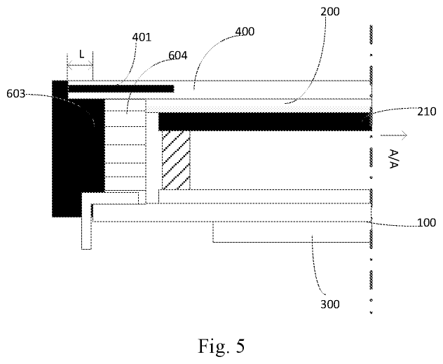

FIG. 5 shows the display device according to the fourth embodiment of the present disclosure.

As shown in FIG. 5, in the fourth embodiment of the present disclosure, the filler may include a filling spacer 604 filled between the second polarizer 400 and the bonding region on the first substrate 100, and a black sealant 603 coated at an outer side of the filling spacer 604. The outer side of the filling spacer 604 may be a side away from the display region of the display panel. A light-shielding layer 401 may be arranged on the edge of the second polarizer 400 at the bonding side of the display panel, and in a direction perpendicular to the first substrate, the light-shielding layer may at least cover a gap between the black sealant and a black matrix on the second substrate but may not cover the display region of the display panel. An orthogonal projection of the black sealant 603 in the direction perpendicular to the first substrate may partially overlap an orthogonal projection of the light-shielding layer 401 in the direction perpendicular to the first substrate, and the orthogonal projection of the light-shielding layer 401 in the direction perpendicular to the first substrate may partially overlap an orthogonal projection of the black matrix 210 in the direction perpendicular to the first substrate. The black sealant 603, the light-shielding layer 401 and the black matrix 210 may together form a light-shielding structure.

Based on the above scheme, after the formation of a cell and the completion of COF bonding, the second polarizer 400 may be attached, so that the orthogonal projection of the light-shielding layer 401 of the second polarizer 400 partially overlaps the orthogonal projection of the black matrix 210 in the direction perpendicular to the first substrate. Then, the filling spacer 604 may be filled in the gap between the second polarizer 400 and the bonding region on the first substrate 100. The filling spacer 604 may include glass spacers, plastic spacers, or both, laminated one on another. After the arrangement of the filling spacer, the black sealant 603 may be applied and cured so as to prevent the light leakage at the sides.

In addition, in the fourth embodiment of the present disclosure, for example, an inner side of the filling spacer 604 may be a side adjacent to the display region of the display panel and may be flush with the edge of the second substrate 200, an inner side of the black sealant 603 may be a side adjacent to the display region of the display panel, an outer side of the black sealant 603 may be a side away from the display region of the display panel, and the outer side of the black sealant 603 may extend beyond the edge of the second polarizer 400 at the bonding side and may be flush with the surface of the second polarizer 400 away from the second substrate 200.

Based on the above scheme, the filling spacer 604 may be filled in the gap between the second polarizer 400 and the first substrate 100, so as to provide a support and flatten the step-like structure. Through the black sealant 603, it is able to seal the periphery of the display panel. In addition, the black sealant 603 may cooperate with the light-shielding layer 401 and the black matrix 210 to form a light-shielding structure, so as to prevent the occurrence of light leakage.

In addition, in the fourth embodiment of the present disclosure, as shown in FIG. 2, the display panel may further include a side other than the bonding side, the edge of the first substrate 100 may be flush with the edge of the second substrate 200 at the side other than the bonding side, and the black sealant 603 may be coated on the edge of the first substrate 100 and the edge of the second substrate 100. An inner side of the black sealant 603 may be a side adjacent to the display region of the display panel, an outer side of the black sealant 603 may be a side away from the display region of the display panel, and the outer side of the black sealant 603 may extend beyond the edge of the second polarizer 400 at the side other than the bonding side and may be flush with the surface of the second polarizer 400 away from the second substrate 200.

Based on the above scheme, no step-like side may be provided at the side of the display panel other than the bonding side, and the edge of the first substrate 100 may be flush with the edge of the second substrate 200. Hence, it is merely necessary to apply the black sealant 603 to prevent the occurrence of light leakage and seal the sides. In addition, the black sealant may be applied to the bonding side and the other sides through a same sealant application process, so it is able to simplify the manufacture process.

It should be appreciated that, in the fourth embodiment of the present disclosure, the filling spacer and the black sealant may together form a filler, so as to flatten the step-like structure and prevent the occurrence of light leakage. As compared with the third embodiment where the filler is formed by the filling adhesive and the black sealant, in the fourth embodiment of the present disclosure, the filling spacer may be directly adhered onto the first substrate through an adhering process rather than through an application process, so it is able to further simplify the manufacture process.

Some descriptions will be given as follows.

(1) The drawings merely relate to structures involved in the embodiments of the present disclosure, and the other structures may refer to those known in the art.

(2) For clarification, in the drawings for describing the embodiments of the present disclosure, a thickness of a layer or region is zoomed out or in, i.e., these drawings are not provided in accordance with an actual scale. It should be appreciated that, in the case that such an element as layer, film, region or substrate is arranged “on” or “under” another element, it may be directly arranged “on” or “under” the other element, or an intermediate element may be arranged therebetween.

(3) In the case of no conflict, the embodiments of the present disclosure and the features therein may be combined to acquire new embodiments.

The above embodiments are merely for illustrative purposes, but shall not be construed as limiting the scope of the present disclosure. The scope of the present disclosure shall be subject to the scope defined by the appended claims.

1. A display device, comprising:
a display panel comprising a first substrate and a second substrate arranged opposite to each other to form a cell, the display panel being provided with a bonding side, and the first substrate extending beyond the second substrate at the bonding side to form a bonding region on the first substrate;
a first polarizer arranged at a side of the first substrate away from the second substrate; and
a second polarizer arranged at a side of the second substrate away from the first substrate,
wherein an edge of the second polarizer extends beyond an edge of the second substrate at the bonding side of the display panel, a gap is formed between a portion of the edge of the second polarizer extending beyond the edge of the second substrate and the bonding region on the first substrate, and a filler is arranged in the gap.

2. The display device according to claim 1, wherein the side of the second substrate away from the first substrate is a display side of the display panel.

3. The display device according to claim 2, wherein the first substrate is an array substrate, and the second substrate is a color filter substrate.

4. The display device according to claim 1, wherein the edge of the second polarizer also extends beyond an edge of the first substrate at the bonding side of the display panel.

5. The display device according to claim 4, wherein the edge of the second polarizer extends beyond the edge of the first substrate by 1 mm to 3 mm at the bonding side of the display panel.

6. The display device according to claim 1, wherein the filler comprises a black filling adhesive filled between the second polarizer and the bonding region on the first substrate, a black matrix is arranged at a surface of the second substrate facing the first substrate, and the black filling adhesive and the black matrix together form a light-shielding structure.

7. The display device according to claim 6, wherein an inner side of the black filling adhesive is a side adjacent to a display region of the display panel, and an outer side of the black filling adhesive is a side away from the display region of the display panel, wherein the inner side of the black filling adhesive is flush with the edge of the second substrate at the bonding side, and the outer side of the black filling adhesive extends beyond the edge of the second polarizer and is flush with a surface of the second polarizer away from the second substrate.

8. The display device according to claim 6, wherein a light-shielding layer is further arranged on the edge of the second polarizer at the bonding side of the display panel, and in a direction perpendicular to the first substrate, the light-shielding layer at least covers a gap between the black filling adhesive and the black matrix but does not cover a display region of the display panel.

9. The display device according to claim 1, wherein the filler comprises a filling adhesive filled between the second polarizer and the bonding region on the first substrate, and a black sealant coated at an outer side of the filling adhesive; the outer side of the filling adhesive is a side away from a display region of the display panel; a light-shielding layer is arranged on the edge of the second polarizer at the bonding side of the display panel, and in a direction perpendicular to the first substrate, the light-shielding layer at least covers a gap between the black sealant and a black matrix on the second substrate but does not cover the display region of the display panel; the black matrix is arranged at a surface of the second substrate facing the first substrate; and an orthogonal projection of the black sealant in the direction perpendicular to the first substrate partially overlaps an orthogonal projection of the light-shielding layer in the direction perpendicular to the first substrate, and the orthogonal projection of the light-shielding layer in the direction perpendicular to the first substrate partially overlaps an orthogonal projection of the black matrix on the second substrate in the direction perpendicular to the first substrate.

10. The display device according to claim 9, wherein the filling adhesive is at least partially filled between the second substrate and the first substrate, an inner side of the black sealant is a side adjacent to the display region of the display panel and adhered to the filling adhesive, an outer side of the black sealant is a side away from the display region of the display panel, and the outer side of the black sealant extends beyond the edge of the second polarizer at the bonding side and is flush with a surface of the second polarizer away from the second substrate.

11. The display device according to claim 1, wherein the filler comprises a filling spacer filled between the second polarizer and the bonding region on the first substrate, and a black sealant coated at an outer side of the filling spacer; the outer side of the filling spacer is a side away from a display region of the display panel; a light-shielding layer is arranged on the edge of the second polarizer at the bonding side of the display panel, and in a direction perpendicular to the first substrate, the light-shielding layer at least covers a gap between the black sealant and a black matrix on the second substrate but does not cover the display region of the display panel; the black matrix is arranged at a surface of the second substrate facing the first substrate; and an orthogonal projection of the black sealant in the direction perpendicular to the first substrate partially overlaps an orthogonal projection of the light-shielding layer in the direction perpendicular to the first substrate, and the orthogonal projection of the light-shielding layer in the direction perpendicular to the first substrate partially overlaps an orthogonal projection of the black matrix on the second substrate in the direction perpendicular to the first substrate.

12. The display device according to claim 11, wherein the filling spacer comprises glass spacers and/or plastic spacers laminated one on another.

13. The display device according to claim 11, wherein an inner side of the filling spacer is a side adjacent to the display region of the display panel and flush with the edge of the second substrate, an inner side of the black sealant is a side adjacent to the display region of the display panel, an outer side of the black sealant is a side away from the display region of the display panel, and the outer side of the black sealant extends beyond the edge of the second polarizer at the bonding side and is flush with a surface of the second polarizer away from the second substrate.

14. The display device according to claim 1, wherein the display panel further comprises a side other than the bonding side, the edge of the first substrate is flush with the edge of the second substrate at the side other than the bonding side, and a black sealant is coated on the edge of the first substrate and the edge of the second substrate, wherein an inner side of the black sealant is a side adjacent to a display region of the display panel, an outer side of the black sealant is a side away from the display region of the display panel, and the outer side of the black sealant extends beyond the edge of the second polarizer at the side other than the bonding side and is flush with a surface of the second polarizer away from the second substrate.
